(19) United States
(12) Patent Application Publication
(10) Pub. No.: US 2003/0133288 A1
(43) Pub. Date: Jul. 17, 2003

(54) Surface uniform illuminating device

(76) Inventors: Paul R. DeBruyne, Naples, FL (US); Jim Eggers, Coral Springs, FL (US); Leslie Schaffer, Fairfield, CT (US); Irving Schaffer, Fairfield, CT (US); Will Goldschmidt, Weston, CT (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/320,165

(22) Filed: Dec. 16, 2002

Related U.S. Application Data
(60) Provisional application No. 60/340,655, filed on Dec. 14, 2001.

(51) Int. Cl. F21S 8/00

(52) U.S. Cl. 362/147; 362/427; 362/287; 362/370

(57) ABSTRACT

An illuminating device for uniformly distributing light over a rectangular portion of a plane is disclosed including a base member, an arm member connected to the base member, and a housing having a trapezoidal aperture, wherein the trapezoidal aperture is fixed in a single unit in operative engagement with the housing and wherein the housing is pivotably attached to the arm member.

### CROSS-REFERENCES TO RELATED APPLICATIONS

This application claims the benefit of U.S. Provisional Application Serial No. 60/340,655, filed on Dec. 14, 2001, entitled SURFACE UNIFORM ILLUMINATING DEVICE.

### TECHNICAL FIELD

This invention relates to a device for and method of evenly distributing light over a surface. In particular, the device and method relates to a lamp having a trapezoidal or other shaped aperture and a smooth curved internal reflector, specifically for illuminating a rectangular plane or other surface having a predetermined area.

### BACKGROUND OF THE INVENTION

This invention relates to a novel illumination source accessory to insure a uniform illumination a surface, thereby insuring that the viewer will receive the full expression that intended to be displayed by the creator.

Illuminating objects, such as hanging works of art, advertisements, displays, and even walls of structures and screens with a lighting fixture of particular design is well known. These known lighting fixtures often comprise a substantially semi-cylindrical shade within which one or more tubular bulbs reside. Typically, the fixture has an extending arm incorporating the wiring, and a perpendicular portion of the extending arm reaches downward and is fixed in position by screws or the like to the back of the frame of the object to be illuminated or other substrate. In this manner, the fixture generally continues above and a particular distance out from the plane to be illuminated.

An array of lamps and lighting devices are known in the lighting art, including lighting devices specifically designed for casting light on pictures or displays. Lamps for pictures typically incorporate an electric light receptacle mounted on a flexible or movable support arm, itself mounted on a connecting structure, either one designed for mounting on a wall or an adjacent support structure or one for mounting on the picture frame or display. The light receptacle often includes a housing, generally with an open bottom functioning as an aperture, and frequently with a reflector to direct the light in the direction of the picture. The support arm may be constructed as a flexible support tube or as the form of one or more rigid arm portions, the position of which can generally be adjusted.

Additionally, numerous picture lamps have been proposed, including ones that use fluorescent light tubes to attain a more uniform lighting of the picture and to cast a light with color attributes that are more akin to the color attributes of sunlight. The more uniform lighting achieved by the use of a fluorescent light tube is due to the light being emitted from numerous points across the length of the light tube instead of from a single point source as is the case in an incandescent light. This, however, results in a penumbra of light that exceeds the boundaries to the rectangular plane sought to be illuminated. This penumbra distributes light over undesirable areas, such as the picture frame of a picture.

Picture frames designed for display frames have been used that are frequently detachably mounted on top of a picture frame using a bracket base. The base is often connected to the frame by means of a clamping mechanism. The devices typically include a lamp receptacle that acts as a reflector and a positionable neck that is connected at a rear end to the bracket and at a front end to the light receptacle. Such lamps do not evenly distribute light over the plane sought to be illuminated and are thus unsuitable.

The picture lighting fixtures of the prior art have been in existence in their current state for over fifty years and are not optimally suited for several reasons: their reflectors are not carefully designed to better reflect light; their apertures that permit the passage of light do not allow for evenly distributing light over a rectangular plane; and their apertures often are constructed in a fashion that enables light to “leak” out, thereby causing light to be unevenly distributed over the potion of the plane sought to be illuminated. More particularly, in the typical known fixture, the reflector is not designed so much to better reflect light out of a shaped aperture as it is designed to shade the light from illuminating anything but the object. As a result, the bulbs used in the known fixtures emit a relatively dim light and are often insufficient to properly light a large piece of artwork. If higher wattage bulbs are used, the light generated will continue to be unevenly distributed, and the heat generated may damage the object or objects sought to be illuminated.

The illumination of works of art, advertisements, displays, and even walls of structures and screens considerably influences human perception of the work, particularly with regard to color. Most works of art, advertisements, displays, and even walls of structures and screens, and the like are frequently created while working in highly illuminated surroundings. However, the resulting works, as a practical matter, are subsequently illuminated with a small light that is positioned above and distanced somewhat away from the plane to be illuminated. Thus the viewer, most often positioned directly in front of the illuminated plane, observes the work in a light different than that in which the work was created. This is a result of the illumination intensity provided by the light source above the plane not being uniform over the surface of the plane. Therefore, the viewer does not realize the true expression of the work because the illumination intensity is distorted. Yet, to date, the lighting fixtures used to illuminate hanging works of art do not seriously address the above-described issues of light diffusion.

It is an object of the present invention to provide an illuminating device that uniformly distributes light over a rectangular portion of a plane.

It is a further object of the present invention to provide an illuminating device with a trapezoidal aperture so as to reduce or eliminate the penumbra caused by light leakage.

It is another object of the present invention to provide an illuminating device that uniformly distributes light over a shaped area of a shaped surface.

It is still another object of the present invention to provide an illuminating device with a shaped aperture so as to reduce or eliminate, the penumbra caused by light leakage.

It is yet another object of the present invention to provide a relatively inexpensive illuminating device for mounting on a substrate, which device will not result in damage to the substrate mounted upon.

Prior to the present invention, an illuminating device and method of uniformly distributing light, that satisfactorily solves the weaknesses associated with the more conventional methods, such as penumbras of light and lack of uniformity of light over the surface, in an efficient, practical and economically affordable manner has not been proposed or suggested by those skilled in the art.

Thus, there is a need for an illuminating device and method of uniformly distributing light that overcomes the aforementioned shortcomings of the prior art.

### SUMMARY OF THE INVENTION

The present invention eliminates the above-mentioned needs for an illuminating device by providing an illuminating device and method of uniformly distributing light.

In accordance with the present invention, there is provided an illuminating device for uniformly distributing light over a rectangular portion of a plane comprising a base member, an arm member moveably connected to the base member, and a housing having a trapezoidal aperture, and also pivotably attached to the arm member.

The present invention is additionally directed to an illuminating device for uniformly distributing light over a shaped surface comprising, a base member, an arm member moveably connected to the base member, and a housing having a shaped aperture, and also pivotably attached to the arm member.

The present invention is further directed to a method for uniformly distributing light over a rectangular area of a plane, the method comprising the steps of angling a trapezoidal aperture of a light source to a first position relative to the plane in a second position, passing light through the trapezoidal aperture from the first position to the second position, and casting a rectangular light pattern substantially equal in area to the rectangular area of the plane.

The present invention is yet further directed to a method for uniformly distributing light over a shaped area of a shaped surface, the method comprising the steps of, angling a shaped aperture of a light source to a first position relative to the shaped surface in a second position, passing light through the shaped aperture from the first position to the second position, and casting a shaped light pattern substantially equal in area to the shaped area of the shaped surface.

### BRIEF DESCRIPTION OF THE FIGURES

FIG. 1 is a cut-away view illustration of the preferred embodiment of the present invention.

FIG. 2 is a side view illustration of the present invention of FIG. 1.

FIG. 3 is an isometric view illustration of an alternative embodiment of the present invention of FIG. 1.

FIG. 4 is a cut-away view illustration of the alternative embodiment of the present invention of FIG. 3.

FIG. 5 is front view illustration of the lighting element of the present invention of FIG. 1.

FIG. 6 is side view illustration of the lighting element of the present invention of FIG. 1.

### DETAILED DESCRIPTION OF THE INVENTION

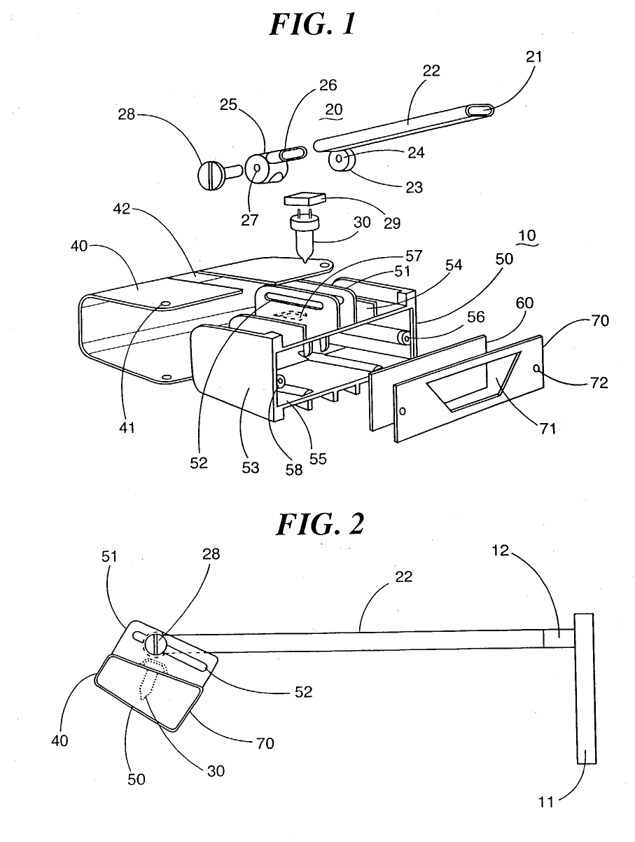

Referring now to FIG. 1, a preferred embodiment of the present invention is illustrated as illuminating device 10. Illuminating device 10 generally comprises a base member 11, an arm member 20 moveably connected to base member 11, a housing 50 having a trapezoidal aperture 70, and also pivotably attached to arm member 20, and a curved reflector 31 internally positioned in housing 50.

As illustrated in FIG. 2, base member 11 attaches to a substrate, such as a wall, ceiling, floor, or display frame. The attachment to the substrate may be releasable or fixed, depending upon the nature of the work to be illuminated. More permanently placed works may necessitate a fixed attachment on the substrate, while more temporary works may demonstrate a need for a releasable attachment.

Base member 11 includes attachment point 12 to accommodate arm member 20. Arm member 20 includes attachment slot 21 for securing arm post 22 to base member 11. This attachment is sufficient to support the weight of the other components of the illuminating device 10.

Referring again to FIG. 1, arm member 20 also includes arm connector 26, which joins arm post 22 to the attachment points 23 and 25. Attachment points 23 and 25 serve to fasten housing 50 to arm member 20. In the preferred embodiment of the present invention, attachment points 23 and 25 serve as the pivot points for housing 50. The housing 50 includes pivot members 51 that include slide grooves 52. Pivot members 51 are positioned adjacent to attachment points 23 and 25, so that a portion of slide grooves 52 pass over threaded holes 24 and 27. Screw member 28 is used to secure slide grooves 52 in a position over threaded holes 24 and 27 with respect to the arm member 20. Thus, the housing 50 is positionable with respect to the arm member 20 and the base member 11.

One benefit of the positionable nature of housing 50 of the preferred embodiment is that it permits the user to perform fine adjustments to the position of housing 50.

Housing 50 is itself covered by a housing sheath 40. Housing sheath 40 is secured to housing 50 by screws or other like securing means at securing points 41. Housing sheath 40 reduces the light leakage that may occur from housing 50. Housing sheath 40 frictionally engages housing 50 at housing sides 53 and housing sheath slot 42 fits around pivot members 51.

As is also shown in FIG. 1, the preferred embodiment of the present invention has housing 50 that includes cooling slots 54. The principal benefit of cooling slots 54 is that they allow for heat produced by lighting element 30 to dissipate out of housing 50, thereby reducing the likelihood of heat damage to the illuminating device 10. The housing sheath 40 and housing 50 combination results in an illumination device that greatly reduces the amount of light leakage.

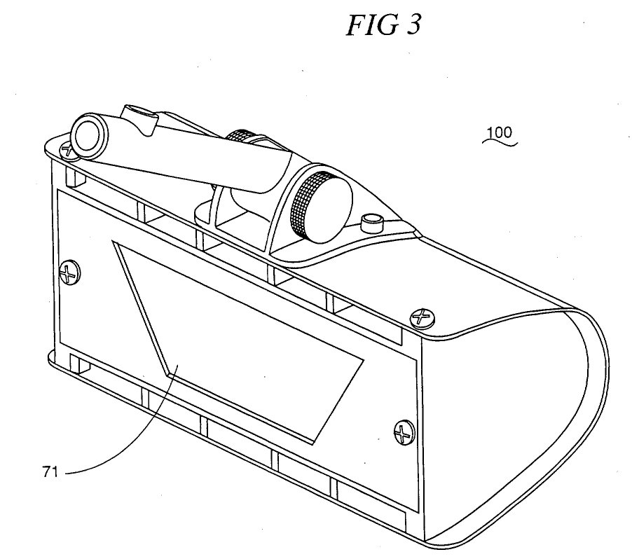

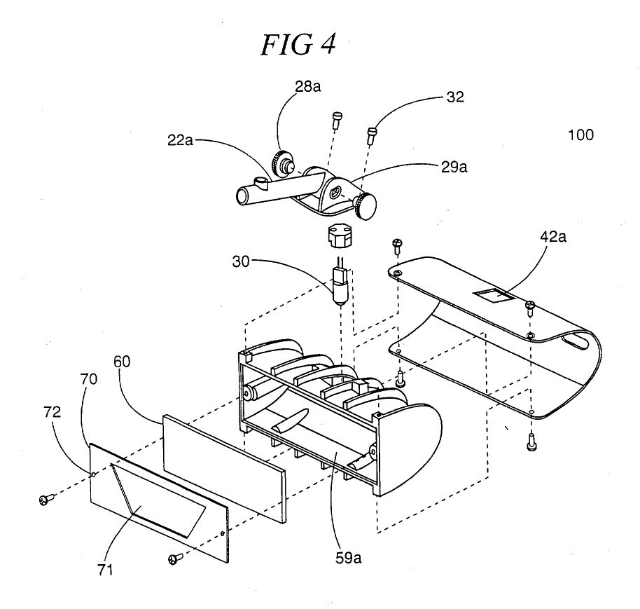

Housing 50 also includes opening 57 for incorporation of lighting element 30. In the preferred embodiment, lighting element 30 is further secured by lighting element bracket 29, which is itself fastened by a screw or similar fastening means to housing 50. Additionally, as illustrated in FIGS. 3 and 4, an alternative embodiment of the illuminating device is shown as illuminating device 100. Illuminating device 100 includes lighting element securement 29a to secure lighting element 30, which passes through opening 42a, and arm member 22a to housing sheath 40 and housing 50. Lighting element securement 29a may be secured to housing sheath 40 and housing 50 by means of a fastener 32. Fastener 33 may any number of fastening means, such as set screws, bolts, screws, and the like.

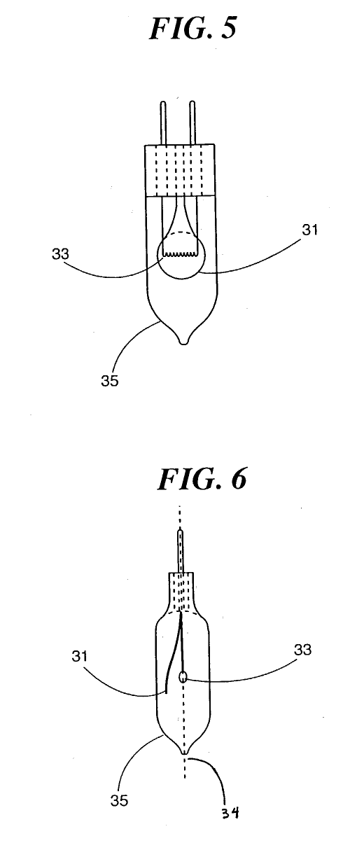

As illustrated in FIGS. 5 and 6, the lighting element of the preferred embodiment can include a housing 35, a filament 33, and an internal reflector 31. Housing 35 permits light to pass therethrough, and may be constructed of numerous materials known in the art that permit the passage of light, such as glass. Referring again to FIGS. 1-6, reflector 31 is suitably shaped to reflect light produced from the rear half of lighting element 30 away from the rear of housing 50 and towards the front of housing 50.

The geometry of internal reflector 31 and its position relative to filament 33 provide a point source of light that produces a light image with a reduced penumbra effect on an illuminated surface. Generally, the greater the distance from the point source of light to the illuminated surface, the more pronounced the penumbra. Positioning internal reflector 31 inside housing 35 and behind filament 33 reduces the penumbra effect. The positioning of internal reflector 31 can reduce the penumbra effect by focusing the point source of light on the less illuminated portion of the illuminated surface. Furthermore, as shown in FIG. 6, it is preferred that internal reflector 31 be angled with respect to longitudinal axis 34 to direct more light towards the lower portion of the surface to be illuminated. Internal reflector 31 may be curved or otherwise suitably shaped to better reflect light from filament 33. Moreover, to reduce light leakage, internal surfaces 59a may be coated in a light absorbing material, such as black paint. Additionally, reflector 31 may also be positioned externally (not shown) of lighting element 30 to produce a similar reflective effect. The benefit of either reflector arrangement is in facilitating a higher output of light directed at the work to be illuminated.

Housing 50 also includes inset groove 55. In the preferred embodiment, inset groove 55 accommodates light filter 60, which can be colorless, colored, transparent, opaque, translucent, shaped or incorporating a picture. In addition, light filter 60 may also be an ultraviolet or infrared light filter. Filter 60 may also be a lens. Such a lens may include fresnel sections to assist in directing light towards the evenly at the lower portion of the surface to be illuminated. Outer edge 58 accommodates shaped aperture 70, which is positioned over light filter 60. Shaped aperture 70 is placed on outer edge 58 and fastened to housing 50 at aperture attachment points 56. Shaped aperture 70 is affixed to housing 50 at aperture attachment points 56 by fastening means such as set screw, bolts, screws or the like.

Shaped aperture 70 includes aperture 71 and housing attachment points 72. Housing attachment points 72 are aligned with aperture attachment points 56 and subsequently fastened by fastening means such as screws or the like. Furthermore, shaped aperture 70 is formed of a single, unitary piece. This construction significantly reduces the amount of light leakage out of housing 50, which, in conjunction with internal reflector 31 and its position relative to filament 33, results in a significant reduction of the penumbra of light typically associated with more traditional illuminating devices.

Moreover, aperture 71 can include a variety of shapes. In one embodiment of the present invention, aperture 71 is trapezoidal in shape. The benefit to using shaped aperture 71 is that it casts a light pattern that, when angled with respect to the corresponding surface to be illuminated, conforms to the exact dimensions of the surface to be illuminated. Thus, with respect to aperture 71 shown in FIG. 1, the trapezoidal shape of the aperture casts a light pattern that appears as a rectangle of on the surface to be illuminated having dimensions exactly conforming to those of the surface to be illuminated, such as a picture. Similarly, in another embodiment, aperture 71 can be formed in a manner that permits a light pattern to be cast that conforms to the surface of any shaped surface to be illuminated.

For example, an unclothed mannequin may be illuminated by the present invention using an aperture shaped in a manner consistent with illuminating the mannequin at a particular angle. At such an angle, the light pattern cast by the illuminating device would cover the mannequin in a clean and clearly defined manner, creating the appearance that the mannequin itself is colored. Moreover, if the filter used incorporated a picture of, for example, clothing, the mannequin would appear to be wearing the clothing projected upon the mannequin. Such a projection, due to the angle of the housing and the shape of the aperture, would appear proportional on the mannequin. A user could easily remove a filter and replace it with another much more quickly than changing a display.

In practicing the method of the preferred embodiment, a front portion of housing 50 is angled with respect to the object to be illuminated so that the aperture 71 is placed in a first position relative to a plane in a second position. The plane in the second position includes the surface to be illuminated, such as a picture, mannequin, or other display piece. Lighting element 30 generates light that passes through the shaped aperture from the first position to the second position, thus lighting the surface. The light is thus cast in a shaped light pattern substantially equal in area to the shaped area of the shaped surface. The cast light pattern, in combination with the reflector internally positioned in the housing, produces a uniform distribution of light over the shaped surface.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. An illuminating device for uniformly distributing light over a rectangular portion of a plane comprising:
a base member;
an arm member connected to said base member; and
a housing having a trapezoidal aperture, wherein said trapezoidal aperture is fixed in a single unit in operative engagement with said housing and wherein said housing is pivotably attached to said arm member.

2. The illuminating device of claim 1 further comprising:
a light filter positioned adjacent to said trapezoidal aperture;
an electric light receptacle mounted within said housing and capable of supporting at least one lighting element; and
an electrical circuit for operating said at least one lighting element, wherein said electrical circuit including wiring extending through said arm member.

3. The illuminating device of claim 2 wherein said base member is releasably attached to a substrate.

4. The illuminating device of claim 3 wherein said substrate is a wall.

5. The illuminating device of claim 3 wherein said substrate is a ceiling.

6. The illuminating device of claim 3 wherein said substrate is a floor.

7. The illuminating device of claim 3 wherein said substrate is a display frame.

8. The illuminating device of claim 1 wherein said arm member is moveable into a plurality of positions relative to said base member.

9. The illuminating device of claim 1 wherein said housing is moveable into a plurality of positions relative to said arm member.

10. The illuminating device of claim 1 wherein said trapezoidal aperture is formed in said single unit.

11. The illuminating device of claim 1 wherein said at least one lighting element includes an internal reflector.

12. An illuminating device for uniformly distributing light over a shaped surface comprising:
a base member;
an arm member connected to said base member; and
a housing having a shaped aperture, wherein said shaped aperture is fixed in a single unit in operative engagement with said housing and wherein said housing is pivotably attached to said arm member.

13. The illuminating device of claim 12 further comprising:
a light filter positioned adjacent to said shaped aperture;
an electric light receptacle mounted within said housing and capable of supporting at least one lighting element; and
an electrical circuit for operating said at least one lighting element, wherein said electrical circuit including wiring extending through said arm member.

14. The illuminating device of claim 13 wherein said base member is releasably attached to a substrate.

15. The illuminating device of claim 14 wherein said substrate is a wall.

16. The illuminating device of claim 14 wherein said substrate is a ceiling.

17. The illuminating device of claim 14 wherein said substrate is a floor.

18. The illuminating device of claim 14 wherein said substrate is a display frame.

19. The illuminating device of claim 12 wherein said arm member is moveable into a plurality of positions relative to said base member.

20. The illuminating device of claim 12 wherein said housing is moveable into a plurality of positions relative to said arm member.

21. The illuminating device of claim 12 wherein said shaped aperture is formed in said single unit.

22. The illuminating device of claim 21 wherein said shaped aperture is elongated along a first aperture portion corresponding to a first surface portion of said shaped surface.

23. The illuminating device of claim 22 wherein said shaped aperture is shortened along a second aperture portion corresponding to a second surface portion of said shaped surface.

24. The illuminating device of claim 12 wherein said at least one lighting element includes an internal reflector.

25. A method for uniformly distributing light over a parallelogram-shaped area of a plane, said method comprising the steps of:
angling a trapezoidal aperture of a light source to a first position relative to said plane in a second position;
passing light through said trapezoidal aperture from said first position to said second position; and
casting a substantially parallelogram-shaped light pattern substantially equal in area to said parallelogram-shaped area of said plane.

26. The method according to claim 25 wherein said trapezoidal aperture is in a single unit in operative engagement with said light source.

27. The method according to claim 25 wherein said parallelogram-shaped light pattern is equal in area to said parallelogram-shaped area of said plane.

28. The method according to claim 25 wherein said parallelogram-shaped light pattern has a uniform intensity over said parallelogram-shaped area of said plane.

29. A method for uniformly distributing light over a shaped area of a shaped surface, said method comprising the steps of:
angling a shaped aperture of a light source to a first position relative to said shaped surface in a second position;
passing light through said shaped aperture from said first position to said second position; and
casting a shaped light pattern substantially equal in area to said shaped area of said shaped surface.

30. The method according to claim 29 wherein said shaped aperture is in a single unit in operative engagement with said light source.

31. The method according to claim 29 wherein said shaped light pattern is equal in area to said shaped area of said shaped surface.

32. The method according to claim 29 wherein said shaped light pattern has a uniform intensity over said shaped area of said shaped surface.

33. A lighting element for an illuminating device comprising:
a housing for permitting the passage of light and having a longitudinal axis;
a filament internally positioned in said housing; and
a reflector internally positioned adjacent to said filament and angled with respect to said longitudinal axis.

34. The lighting element of claim 33 wherein said filament produces light.

35. The lighting element of claim 33 wherein said housing means is glass.
